(19) United States
(12) Patent Application Publication
(10) Pub. No.: US 2013/0138537 A1
(43) Pub. Date: May 30, 2013

(54) SYSTEM FOR AND METHOD OF MANAGING FIBER REEL DATA AT A CENTRALIZED LOCATION

(71) Applicants: Todd Hart, Cary, NC (US); William H. Axelrod, II, Raleigh, NC (US)

(72) Inventors: Todd Hart, Cary, NC (US); William H. Axelrod, II, Raleigh, NC (US)

(73) Assignee: VERIZON PATENT AND LICENSING, INC., Basking Ridge, NJ (US)

(21) Appl. No.: 13/307,516

(22) Filed: Nov. 30, 2011

(51) Int. Cl. G06Q 10/06

(52) U.S. Cl. 705/28

(57) ABSTRACT

A system for and method of managing fiber reel data at a centralized location is presented. A centralized database may track and maintain fiber cable reels stored throughout one or more networks. The system and method may include receiving a request from a user to access a centralized database comprising fiber reel data for one or more locations; providing one or more management options for managing fiber reel data to the user, wherein the one or more management options comprise managing fiber reel data inventory on a location specific basis; and displaying fiber reel data on a display comprising a tree panel, a location panel and an inventory panel, the display further providing an option to view a map display illustrating fiber reel inventory for one or more site locations.

### BACKGROUND INFORMATION

Many services, including Internet, telephone and television services, operate over a fiber-optic communications network. Service providers often use fiber optics in the network backbone and existing copper or infrastructure for residential users. Optical fibers are widely used in fiber-optic communications. Optical fibers are generally placed on a reel for storage within a warehouse location. Because there are so many different uses for optical fibers, various characteristics may be associated with each fiber reel. Currently, fiber reel data is maintained in a distributed manner across many locations. Because the data is dispersed, when an emergency arises, it may be difficult to obtain an accurate inventory of available fiber reel at a particular location.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system for managing fiber reel data according to particular embodiments;

FIG. 2 is a block diagram of a hardware component of the application system of a particular embodiment;

FIG. 3 is an exemplary illustration of a user interface for managing fiber reel data, according to a particular embodiment;

FIG. 4 is an exemplary illustration of an interface displaying a screen shot of a management function, according to a particular embodiment;

FIG. 5 is an exemplary illustration of an interface displaying a screen shot of a management function, according to a particular embodiment;

FIG. 6 is an exemplary illustration of an interface displaying a screen shot for managing fiber reel data, according to a particular embodiment;

FIG. 7 is an exemplary illustration of an interface displaying a screen shot of a details window, according to a particular embodiment;

FIG. 8 is an exemplary illustration of an interface displaying a screen shot of a map view, according to a particular embodiment;

FIG. 9 is an exemplary illustration of an interface displaying a screen shot of a radius search, according to a particular embodiment;

FIG. 10 is an exemplary illustration of an interface displaying a screen shot of a map view with graphics, according to a particular embodiment;

FIG. 11 is an exemplary illustration of an interface displaying a screen shot of a map view with directions, according to a particular embodiment;

FIG. 12 is an exemplary illustration of an interface displaying a screen shot of an administer view, according to a particular embodiment;

FIG. 13 is an exemplary illustration of an interface displaying a screen shot for a management function, according to a particular embodiment;

FIG. 14 is an exemplary illustration of an interface displaying a screen shot of a management function, according to a particular embodiment;

FIG. 15 is an exemplary illustration of an interface displaying a screen shot of a management function, according to a particular embodiment;

FIG. 16 is an exemplary illustration of an interface displaying a screen shot of an insert function for managing fiber data, according to a particular embodiment; and

FIG. 17 is a flowchart illustrating the functionality of a particular embodiment.

### DETAILED DESCRIPTION OF PREFERRED EMBODIMENTS

An exemplary embodiment provides a system and a process for a managing fiber reel data at a centralized location. A centralized database may track and maintain fiber cable reels stored throughout one or more networks. An embodiment of the present invention is directed to a Fiber Cable Reel (FCR) Database which aids in reduction of fiber cable restoration times and costs by providing improved management of the cable inventory. During fiber outage situations, it is vital for an organization to have an accurate fiber cable reel inventory. Through utilization of an embodiment of the present invention, fiber cable reels may be accurately located and quickly mobilized.

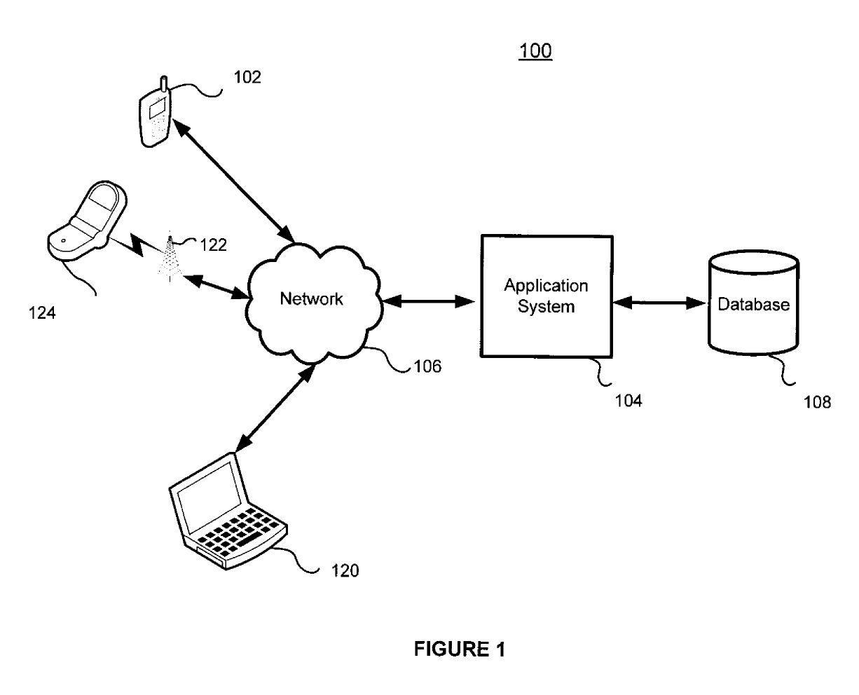

FIG. 1 is a schematic diagram illustrating a system for managing fiber reel data according to particular embodiments. As illustrated in FIG. 1, system 100 may include a user communication device 102 associated with a user accessing a centralized system of an embodiment of the present invention. The user may establish a communication session with a communication device and an application system 104 via a communication network 106. The communication network 106 may be communicatively coupled with other devices such as a computer 120. Other communication device associated with the user may communicate with the communication network 106 via one or more intermediary devices, such as a transmitter/receiver 122. For example, a wireless mobile communication device 124 may communicate with the communication network 106 via the transmitter/receiver 122.

The user communication device 102 may be a computer, a personal computer, a laptop, a cellular communication device, a workstation, a mobile device, a phone, a handheld PC, a personal digital assistant (“PDA”), a thin system, a fat system, a network appliance, an Internet browser, or other any other device that may allow a user to communicate with the application system 104 and the plurality of communication devices (e.g., the computer 120, the wireless mobile communication device 124, etc.) associated with other users via the communication network 106. For example, a user associated with the user communication device 102 may transmit to and receive from the application system 104, one or more message signals via the communication network 106.

The application system 104 may include one or more servers. For example, the call control application system 104 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, or other independent server to relay one or more transmitted messages from a first user to an intended recipient. Also, the call control application system 104 may include one or more Internet Protocol (IP) network server or public switch telephone network (PSTN) server.

The application system 104 may include one or more databases, as represented by Database 108. For example, the application system 104 may include a flash memory, a redundant array of inexpensive disks (“RAID”), tape, disk, a storage area network (“SAN”), an interne small computer systems interface (“iSCSI”) SAN, a Fibre Channel SAN, a common Internet File System (“CIFS”), network attached storage (“NAS”), a network file system (“NFS”), or other computer accessible storage. Also, the application system 104 may include one or more Internet Protocol (IP) network server and/or public switch telephone network (PSTN) server. For example, the application system 104 may process data requests over the communication network 106 using Internet Protocol (IP).

Other storage devices may include, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

The communication network 106 may be coupled to the application system 104 and one or more communication devices (e.g., the user communication device 102, the computer 120, the wireless mobile communication device 124, etc.). The communication network 106 may be a wireless network, a wired network or any combination of wireless network and wired network. For example, the communication network 106 may include one or more of a public switched telephone network (PTSN), a signaling system #7 (SS7) network, a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the communication network 106 may include, without limitation, telephone line, fiber optics, IEEE Ethernet 802.3, wide area network (“WAN”), local area network (“LAN”), or global network such as the Internet. The communication network 106 may support an Internet network, a wireless communication network, a cellular network, or the like, or any combination thereof. The communication network 106 may further include one, or any number of the exemplary types of networks mentioned above operating as a stand-alone network or in cooperation with each other. The communication network 106 may include a plurality of mobile switching centers (MSCs) and a plurality of signaling control points (SCPs).

The communication network 106 may utilize one or more protocols of one or more network elements to which it is communicatively coupled. The communication network 106 may translate to or from other protocols to one or more protocols of network devices. Although the communication network 106 is depicted as one network, it should be appreciated that according to one or more embodiments, the communication network 106 may comprise a plurality of interconnected networks, such as, for example, a service provider network, the Internet, a broadcaster's network, a cable television network, corporate networks, and home networks.

The transmitter/receiver 122 coupling the wireless mobile communication device 124 to the communication network 106 may be a repeater, a microwave antenna, a cellular tower, or another network access device capable of providing connectivity between two different network mediums. Transmitter/receiver 122 may be capable of sending and receiving signals via a mobile network, a paging network, a cellular network, a satellite network or a radio network. Transmitter/receiver 122 may provide connectivity to one or more wired networks and may be capable of receiving signals on one medium such as a wired network and transmitting the received signals on a second medium such as a wireless network.

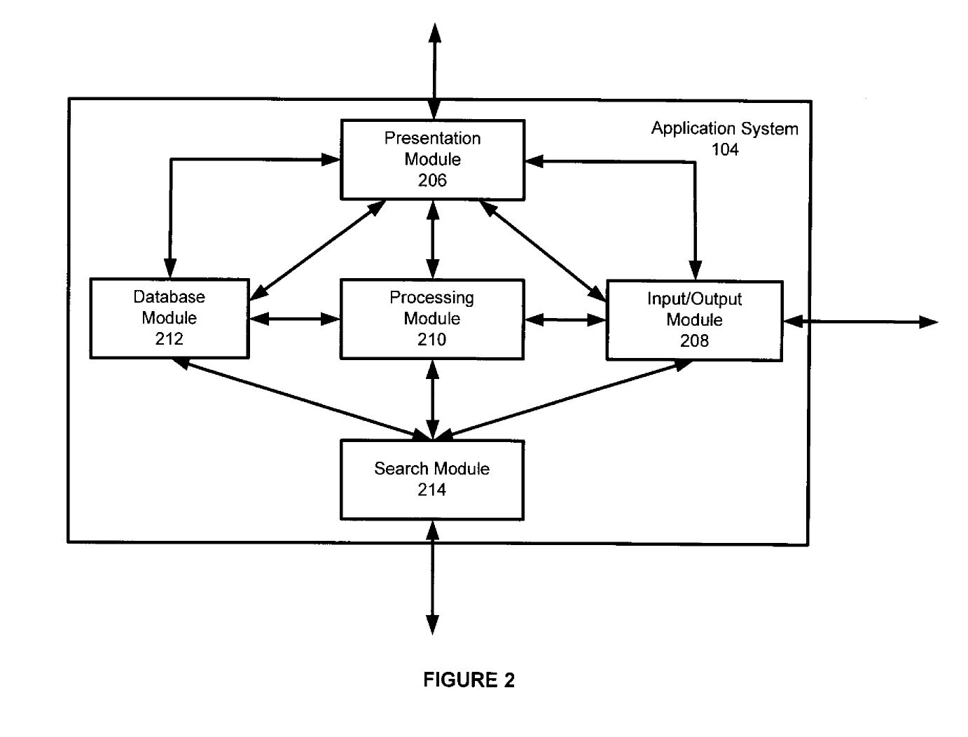

FIG. 2 is a block diagram of a hardware component of the application system of a particular embodiment. The application system 104 may include a presentation module 206, an input/output module 208, a processing module 210, a database module 212, and a search module 214. It is noted that the modules 206, 208, 210, 212, and 214 are exemplary and the functions performed by one or more of the modules may be combined with that performed by other modules. The functions described herein as being performed by the modules 206, 208, 210, 212, and 214 also may be separated and may be located or performed by other modules. Moreover, the modules 206, 208, 210, 212, and 214 may be implemented at other components of the system 100.

The input/output module 208 may receive one or more requests from the user communication device 102. The availability of certain functions and access to certain data may be based on the user's authorization or access level. Also, a user may send a request to export a subset or all inventory records for a selected location. When the user selects a file to bulk load, the user may insert new records and/or update existing records. The file may be processed where a progress file may be generated and returned to the user. In the event any rows failed to be inserted, those rows may be displayed in the progress report and the field that caused the failure may be highlighted for the failed row.

The request messages may be transferred from the input/output module 208 to the processing module 210 for processing. The processing module 210 may process fiber reel data and also provide management options. Fiber reel data may include reel identifier, manufacturer, fiber count, meters, feet, molding type, strength member, cable type, etc. Various management options may include add, edit, delete, etc. Contact information may also be managed for each location as well as fiber reel. In another exemplary embodiment, the processing module 210 may access the database module 212 to manage fiber reel data.

The presentation module 206 may provide an interface between the communication devices (e.g., user communication device 102, the computer 120, the wireless mobile communication device 124, etc.). The presentation module 206 may include a user interface, e.g., a graphical user interface, to receive one or more queries/requests from users via the communication devices. The presentation module 206 may provide a separate or a unified graphical user interface. The presentation module 206 may include an Application Programming Interface (API) to interact with the communication devices (e.g., the user communication device 102, the computer 120, the wireless mobile communication device 124). In an exemplary embodiment, the presentation module 206 may present one or more graphical contents or displays to the users associated with the communication devices.

In another exemplary embodiment, the presentation module 206 may receive one or more queries/requests from a communication device (e.g., the user communication device 102, the computer 120, the wireless mobile communication device 124, etc.). In response to receiving the one or more queries/requests from a user via the communication device, the presentation module 206 may provide the one or more queries/requests to the input/output module 208, the processing module 210, the database module 212, and the search module 214. For example, the presentation module 206 may receive one or more queries/requests from the communication device. In response to receiving the one or more queries/requests from the user via the communication device, the presentation module 206 may send the one or more queries/requests to the database module 212 and/or the search module 214 to create search queries.

The database module 212 may create and store identification information and/or information associated with contact information based at least in part on the one or more received queries/requests. The search module 214 may also create and store identification information associated with fiber reel data and/or location specific information based at least in part on the one or more received queries/request.

In other exemplary embodiments, the presentation module 206 may receive one or more queries/requests from a communication device (e.g., the user communication device 102, the computer 120, the wireless mobile communication device 124, etc.) to manage fiber reel data. Also, the presentation module 206 may provide the one or more queries/requests to the processing module 210 and the processing module 210 may display inventory information as well as graphical representations of the inventory information.

The database module 212 may store and manage fiber reel data. The database module 212 may provide an interface, e.g., a uniform interface, for other modules within the application system 104 and may write, read, and search parties information stored in one or more repositories or databases. The database module 212 may also perform other functions, such as, but not limited to, concurrent access, backup and archive functions. Due to limited amount of storing space the database module 212 may compress, store, transfer or discard the public domain re-use service account information associated with parties of a communication session stored within, after a period of time, e.g., a year. The database module 212 may provide fiber reel data and location specific data to the processing module 210. The database module 212 may be network accessible storage and may be local, remote, or a combination thereof to modules 206, 208, 210, and/or 214.

The database module 212 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, database module 212 may be a database, such as an Oracle database, a Microsoft SQL Server database, a DB2 database, a MySQL database, a Sybase database, an object oriented database, a hierarchical database, or other database. The database module 212 may utilize flat file structures for storage of data.

The search module 214 may provide an interface between the application system 104 and a plurality of communication devices associated with a called party (e.g., the computer 120, the wireless mobile communication device 124, etc.). For example, the search module 214 may receive search input data and provide search results in various useful formats, including graphical displays, map views and/or listings. The search module 214 may interact with database module 212 to update and/or modify fiber reel data.

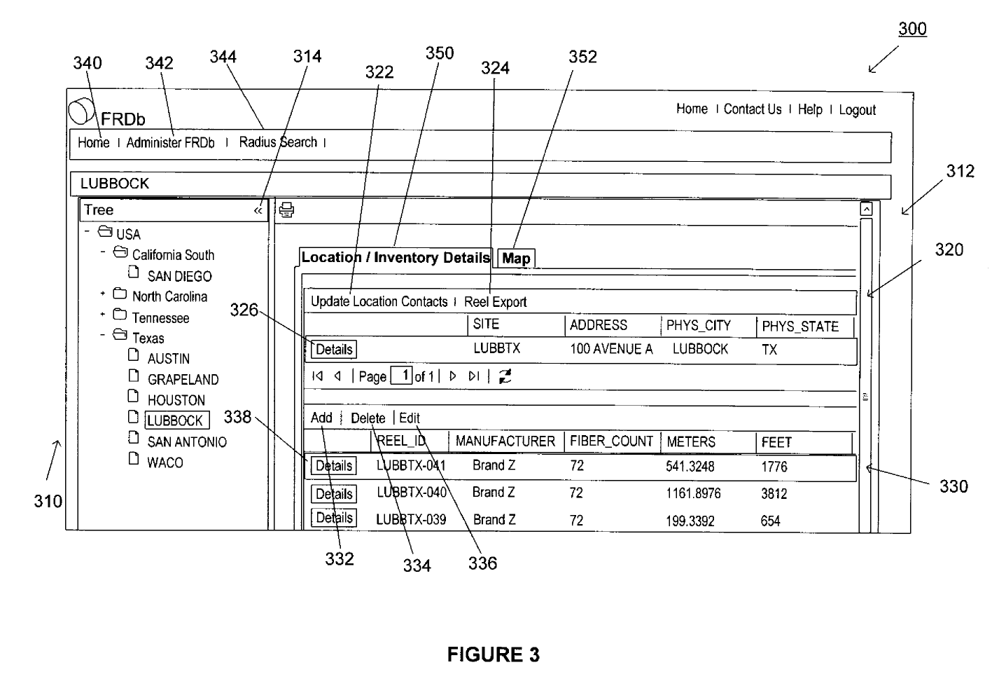

FIG. 3 is an exemplary illustration of a user interface, according to a particular embodiment. The user interface 300 may include various panels, including a tree panel 310 and a main panel 312. The main panel 312 may display location/inventory details, by selecting tab 350 or map details, by selecting tab 352. Upon selecting tab 350, main panel may display location panel 320 and inventory panel 330. Map tab 352 may display a map graphic as described in further detail below. Other navigation options, such as Home 340, Administer FRDb 342 and Radius Search 344 may be available.

Tree Panel 310 may display a hierarchical view of locations where each location may include fiber reel data specific to that location. The Tree Panel may include collapsible and expandable nodes. For example, within the USA, additional regions, such as states, may be displayed. Within each expandable state, sub-regions such as cities, counties or other defined areas may be displayed. Tree Panel 310 may act as a filtering mechanism for the data grid and map components. By selecting an area in tree panel 310, the relevant details for the selected area may be displayed in main panel 312. Tree contents may be data driven and updateable by collapsing and expanding an interested node. The tree panel may automatically refresh during add, edit and delete requests on the city and state level for reel inventory. The tree panel may also be collapsed to expand the page area by selecting the symbol 314 in the upper right corner.

Location Panel 320 may provide fiber reel data detail for a location corresponding to a selected location on the tree panel 310. For example, site, address, city and site information may be provided. Other information may be available as well. The Location grid header may include Update Location Contacts 322 and Reel Export 324. Update Location Contacts 322 may be visible for users with access to modify contact information for that location. The footer of the grid may contain page navigation features and an option to refresh the grid.

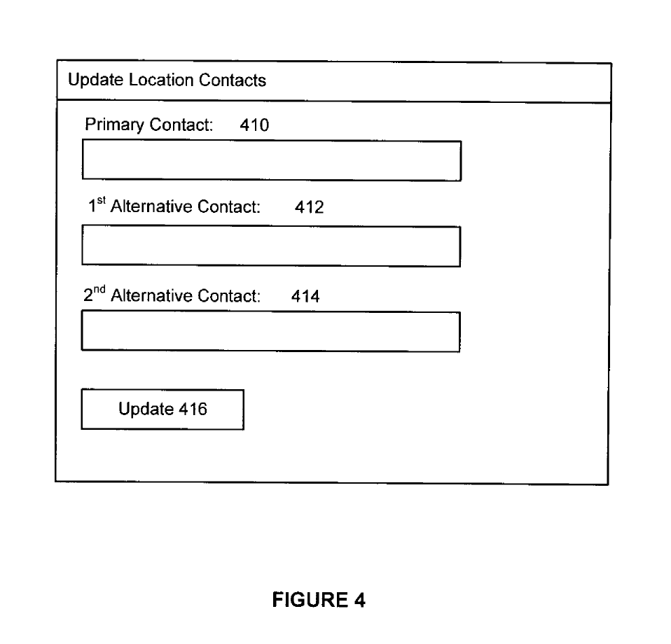

FIG. 4 is an exemplary illustration of an interface displaying a screen shot of an Update Location Contacts function, according to a particular embodiment. Upon selecting Update Location Contacts 322, a window—such as FIG. 4—may appear allowing the user to add or modify data related to a primary contact, as shown by 410, a first alternative contact, as shown by 412 and a second alternative contact, as shown by 414. The Primary Contact may be a required field and may not be left blank. These contacts may have predefined edit rights and may be notified via email or other form of communication during any change to a reel or site. A user may select an Update button 416 to effectuate the changes or confirm the current information.

Reel Export 324 may allow the user to export a subset or all inventory records for a selected location. When the user selects a file to export, the user may insert new records and/or update existing records. The file may be processed where a progress file may be generated and returned to the user. In the event any rows failed to be inserted, those rows may be displayed in the progress report and the field that caused the failure may be highlighted for the failed row.

Location Panel 320 may include a site code and physical address information in addition to latitude and longitude values. A Details button 326 may also be available for more extensive information about the location, change logs and other editing functions. Column headers are clickable to allow for alternative sorting.

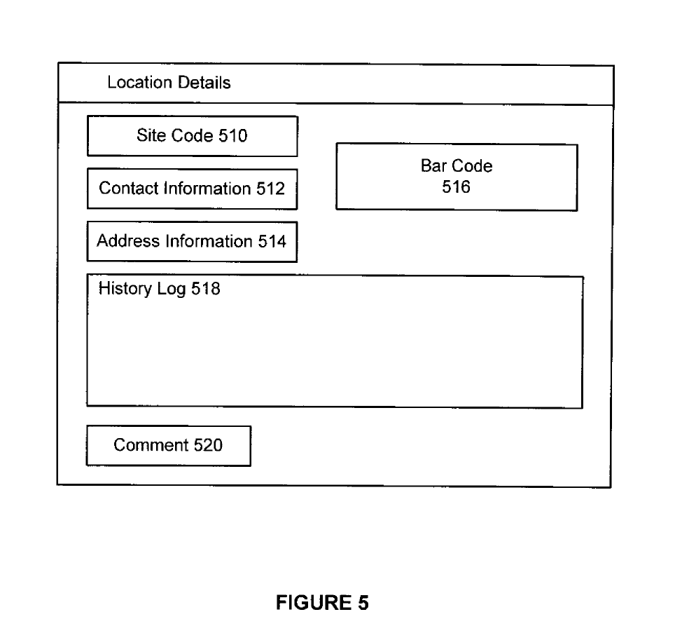

FIG. 5 is an exemplary illustration of an interface displaying a screen shot of a Location Details, according to a particular embodiment. By selecting Details button 326, a details window may display site code 510, contact information 512 and physical address 514 information. A Barcode 516 may also be displayed so a facilities technician may print the details label and post it at the location. This bar code feature may be in conjunction with a mobile phone application that allows the field technician to scan the bar code, update form fields and submit changes on-demand on-site. A history log 518 may provide details concerning changes applied to the location. For example, the user may modify the latitude and longitude coordinates, if the user has modification rights for the location. Upon selecting the comments button 520, comments may be entered. For example, the user may be supplied with a text area to input comments about the physical Location.

An Inventory Panel 330 may provide information concerning fiber reel data and also provide management options. The Inventory Panel 330 may display fiber reel data for each fiber reel. Data may include reel identifier, manufacturer, fiber count, meters, feet, molding type, strength member, cable type, etc. The header of the Inventory grid may contain various management options, such as Add 332, Edit 334 and Delete 336. The management options buttons may be visible to users with access to modify reel entries for the selected location.

The Add option 332 may allow the user to add fiber feel data to the inventory. The Edit option 336 may allow the user to modify an existing reel. For example, values may be pre-populated in the edit form. After clicking Delete 334 on a selected reel, the user may be prompted with a message requesting that the delete be verified before continuing. A Details button 338 is also available for extensive details on the fiber specifics, change logs and other editing functions. Column headers may be clickable to allow for alternative sorting.

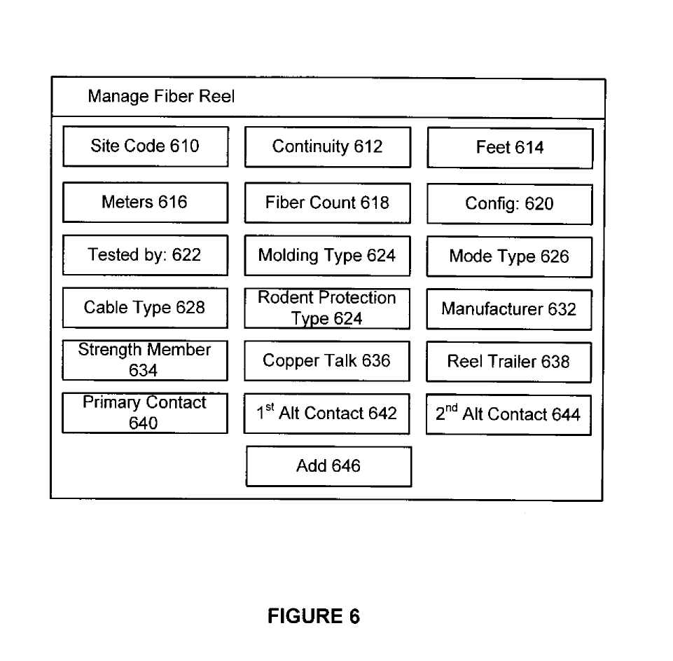

FIG. 6 is an exemplary illustration of an interface displaying a screen shot for managing fiber reel data, according to a particular embodiment. After clicking the Add option 332 for a selected site location, a window may appear with the selected site code pre-populated, as shown by 610. The available options for each input box may be bound to administrative data and automatically update available options without screen refresh.

For Site Code input 610, a user may be prompted to enter a side code, e.g., 6 letter SCIS site code where a particular fiber reel is stored. If this location does not have a SCIS code, a new site code may be added using the Admin NON-SCIS Site Code feature located under the Administer FRDb tab.

For Continuity input 612, a user may enter the date the fiber was tested. Also, this field may be automatically populated.

For Feet input 614, a user may enter the length of the cable in feet. Upon input of the Feet input, the Meters field may auto calculate the conversion and update the input box.

For Meters input 616, a user may enter the length of the cable in meters. Upon input of the Meters input, the Feet field may auto calculate the conversion and update the input box.

For Fiber Count input 618, a user may enter the number of fibers in the cable. For example, the number 48 may represent 48 fibers in a cable.

For Config input 620, a user may enter the configuration of the fiber in the cable. For example, a user may enter 6-6-6-4 for a 22 fiber cable with six fibers in the first tube or slot, six fibers in the second tube or slot, six fibers in the third tube or slot, and four fibers in the fourth tube or slot. According to another example, a user may enter 12-12-12-12 for a 48 fiber ribbon cable with 12 fibers in each ribbon. According to yet another example, a user may enter 18×24 for a 432 fiber ribbon cable with 18 ribbons of 24 fibers in each ribbon.

For Tested By input 622, a user may enter the name of the person that tested this fiber cable. Also, this field may be automatically populated.

For Molding Type input 624, by utilizing a dropdown option, a user may select various options including “Slot” if the fibers are in an open slot (such as a star-chamber and STC type cables), “Tube” if the fibers are in a buffer tube, “Ribbon” if the fibers are in a ribbon, “LightPack-AT&T” if the fibers are AT&T uni-tube, or “Tight Buffer” if the fibers are in a tight buffer configuration (such as some Sumitomo cables). Other options may be available.

For Mode Type input 626, by utilizing a dropdown option, a user may select an appropriate type of glass. For example, a user may select Multi-mode, Single Mode, Dispersion Shifted, LS (Lambda Shifted), Medium Dispersion, Truewave, TLUltra, Hybrid, and other mode types.

For Cable Type input 628, by utilizing a dropdown option, a user may select one of the following: Dielectric, Metallic, FOGW, FONR, Sub-Marine, ADSS, or Other. Other options may include Unarmored for cables with no metallic properties; Single Armored for cables with single armor/Rodent Protection Sheath; Double Armored for cables with double armor/Rodent Protection Sheath; FOGW for Fiber Optic Ground Wire; FONR for Fiber Optic Non-Retardant (used inside buildings/fire resistant cable/also called Plenum cable); Sub-Marine for Oceanic cable (used under water); ADSS for All Dielectric Self Supporting cable (used in applications that require the cable to be installed close or near commercial power lines); Micro Cable for cables used inside microduct; and Other for other cables that do not fall into any of the categories described above.

For Rodent Protection Sheath input 630, by utilizing a dropdown option, a user may select an appropriate rodent protection sheath (RPS). A user may select “None” if the cable does not have a RPS. Most metallic cables have a “Single Armor” RPS.

For Manufacturer input 632, by utilizing a dropdown option, a user may select the name of the fiber cable manufacturer, such as Alcoa, AT&T, Corning Cable Systems, Fitel, General, Northern Telecom, Pirelli, Siecor, Sumitomo, etc.

For Strength Member input 643, by utilizing a dropdown option, a user may select “Metallic” or “Non-Metallic” depending on the type central strength member in the cable. For example, most newer cables have a “Non-Metallic” central strength member.

For Copper Talk Pair input 636, by utilizing a dropdown option, a user may select “Yes” if the cable has a copper talk pair for location or talk purposes, or “No” if the cable does not have a copper talk pair. Other options may be available.

For Reel Trailer input 638, by utilizing a dropdown option, a user may enter “Yes” if a reel trailer is available at the location where the cable is stored or “No” if a reel trailer is not available at the location where the cable is stored. Other options may be available.

For Primary Contact input 640, a user may enter contact information, such as an e-mail address, of the primary contact. Other contact information, such as a phone number, may be provided. For First Alternative Contact input 642, a user may enter the e-mail address of the First Alternative contact. For Second Alternative Contact input 644, a user may enter the e-mail address of the Second Alternative contact. After entering the information above, a user may click on the “Add” button 646.

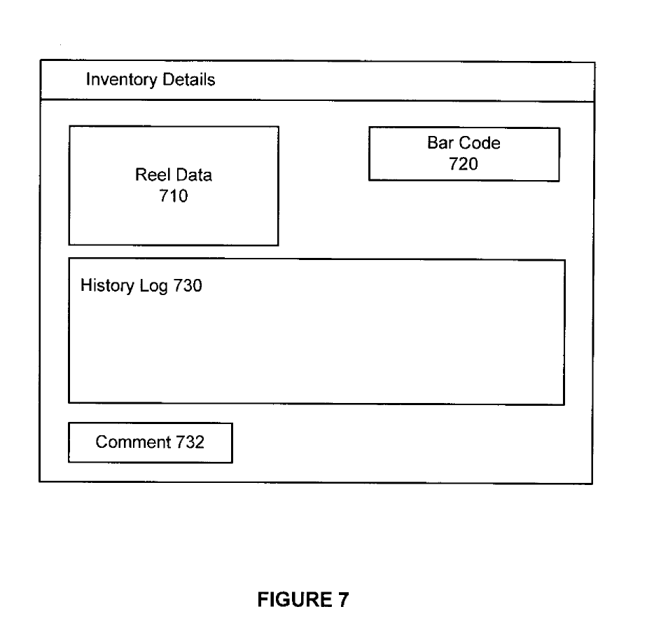

FIG. 7 is an exemplary illustration of an interface displaying a screen shot of a details window, according to a particular embodiment. By selecting Details 338 in FIG. 3, a Details window may display fiber type details available for the specific reel, as shown in 710. For example, Copper Talk and Reel Trailer may have Boolean options. A Barcode 720 may be displayed so a facilities technician may print a details label and post it at the physical reel. This may be used with a mobile phone application that allows the field technician to scan the bar code and update form fields and submit changes on-demand. A history log 730 may provide details concerning changes applied to the reel. Upon selecting the comments button 732, the user may be supplied with a text area to input any comments about the reel. The footer of the grid may contain page navigation features and an option to refresh the grid.

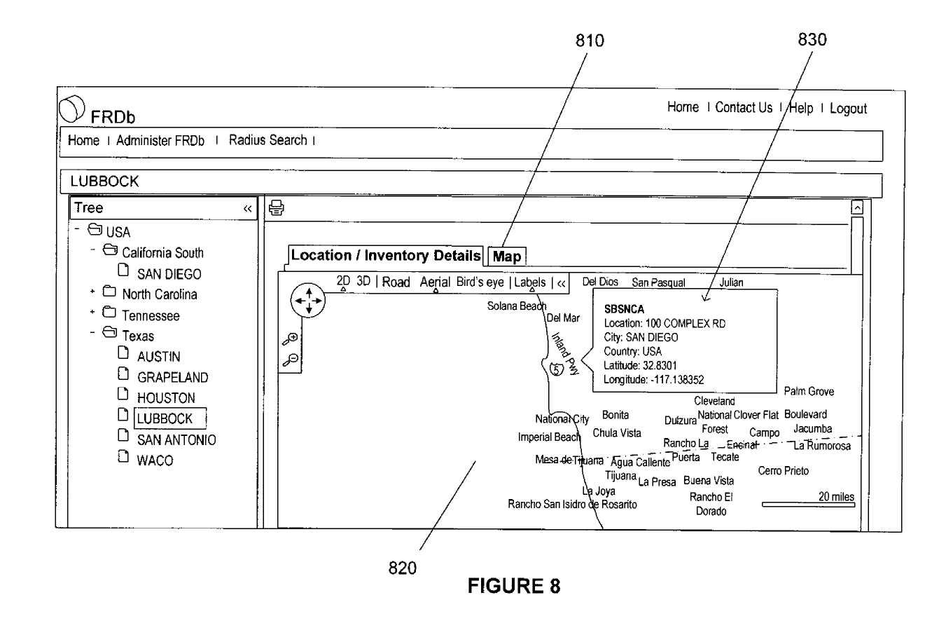

FIG. 8 is an exemplary illustration of an interface displaying a screen shot of a map view, according to a particular embodiment. By selecting a Map tab 810, a Map view 820 may display physical locations of site or sites with graphics, such as red push pins. Each location may be displayed by location data which may include corresponding latitude-longitude coordinates. Locations may be displayed at the State, City and single site level. When the user hovers over a push pin location, details about the site may be displayed through a comment box 830. The comment box 830 may include the site code, physical address, latitude and longitude coordinates as well as other customized information.

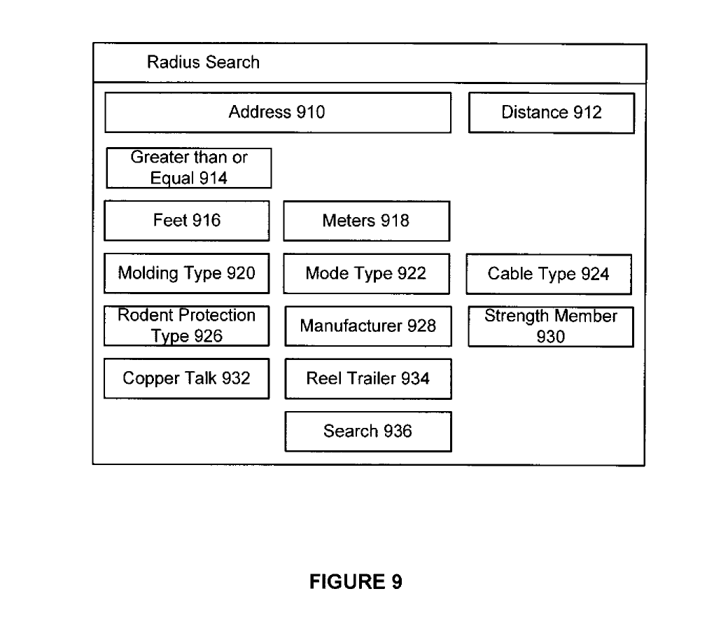

FIG. 9 is an exemplary illustration of an interface displaying a screen shot of a radius search, according to a particular embodiment. A Radius Search may allow a user to search within a defined area. When clicking the Radius Search, as shown as 344 in FIG. 3, a window may appear where the user may input search criteria, such as a start location 910, distance from the start location to search for fiber reels 912 and other available filtering mechanisms to further narrow and focus the search, as shown by 914. Other criteria may be provided to further narrow the search results. For example, data relating to fiber length, including feet 916, meter 918, molding type 920, mode type 922, cable type 924, rodent production type 926, manufacturer 928, strength member 930, copper talk 932, reel trailer 934 may be entered. By selecting 936, search results may be provided via a map graphic, listing or other display.

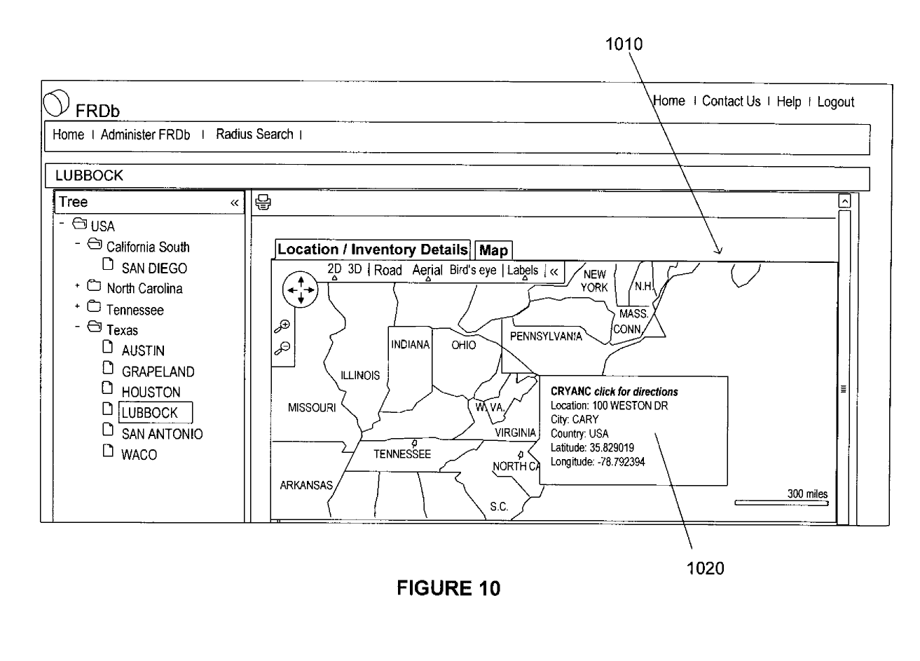

FIG. 10 is an exemplary illustration of an interface displaying a screen shot of a map view 1010 with graphics, according to a particular embodiment. Corresponding results from radius search may appear in a map with graphics. Results may be identified by red thumb-tacks or other graphic. Each thumb-tack when hovered over may display information in a comment box 1020 about where the reel is located.

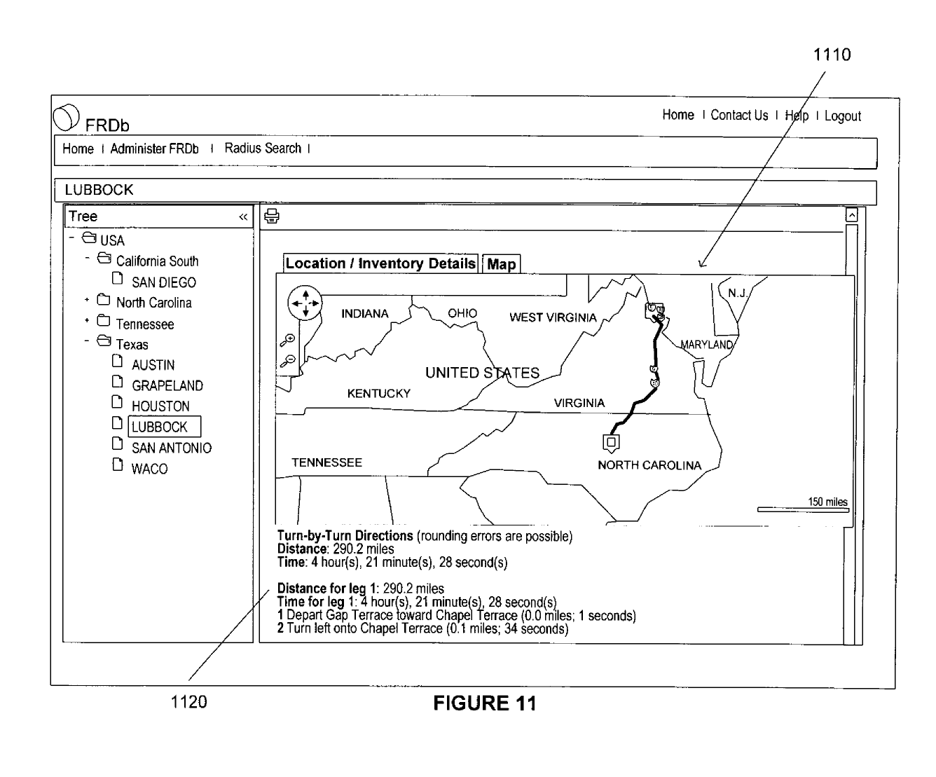

FIG. 11 is an exemplary illustration of an interface displaying a screen shot of a map view with directions, according to a particular embodiment. In comment box 1020 shown in FIG. 10, a hyper-link labeled ‘click for directions’ may be displayed. Upon selecting this option, the map may redraw, as shown by 1110, and provide turn by turn directions from the start location to a selected end route, as shown by 1120.

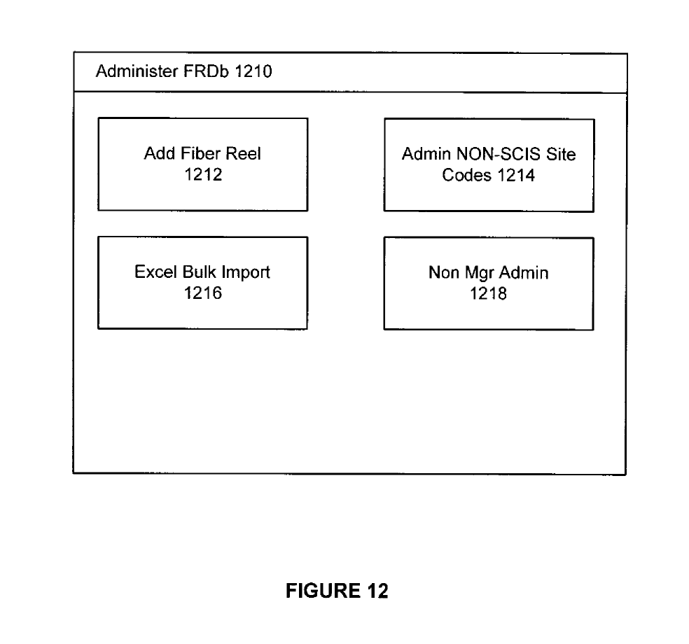

FIG. 12 is an exemplary illustration of an interface displaying a screen shot of an administer view, according to a particular embodiment. To access the Administrator panel, Administer FRDb tab 1210 may be selected. The Administrative panel for FRDb may be accessible by managers of a location or other authorized users. Certain functions may be available including Add Fiber Reel 1212, Site Codes 1214, Bulk Import 1216, and Non Management Administration 1218.

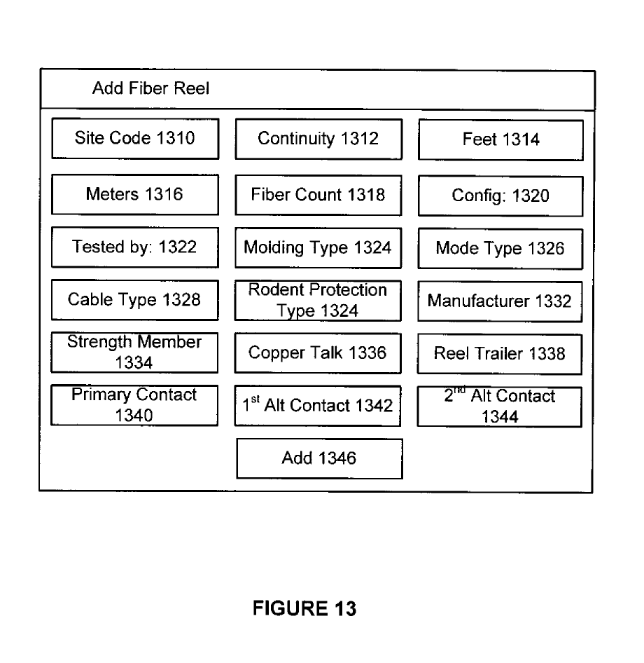

FIG. 13 is an exemplary illustration of an interface displaying a screen shot for adding a fiber reel, according to a particular embodiment. When adding a new fiber reel by selecting Add Fiber Reel 1212 from FIG. 12, a window, such as FIG. 13, may appear. The site code input field may check against the FRDb site code list to validate site code name 1310. For Continuity 1213, the user may input the current date or this field may be automatically populated. Feet input 1314 and meters input 1316 may auto calculate the conversion and update the input box if either of the values are modified. Other input boxes may include Fiber Count 1318, Configuration 1320, Test by 1322, Molding Type 1324, Mode Type 1326, Cable Type 1328, Rodent Protection Type 1330, Manufacturer 1332 and Strength Member 1334 are managed through the administration panel. Other fields may include Copper Talk 1336, Reel Trailer 1338, Primary Contact 1340, First Alternate Contact 1342 and Second Alternative Contact 1344. By selecting the Add button 1346, a fiber reel may be added to inventory.

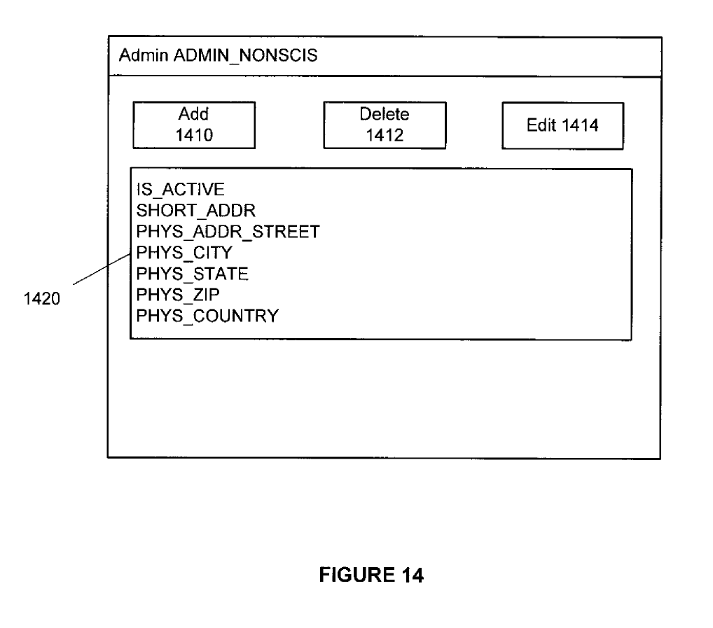

FIG. 14 is an exemplary illustration of an interface displaying a screen shot of adding a site code, according to a particular embodiment. A Non-SCIS Site Code entry may be created in the event a reel is at a site that is not found in Site Code Information System (SCIS). When adding a new site code by selecting Add 1410, the input entries may be provided at 1420. When a state is selected, available cities for the state may populate the city combo box. When the city is selected, those zip codes available may appear. In the event a city or zip code is not available, the user to type in a custom city name or zip code into the system. Other options, such as Delete 1412 and Edit 1414 are available.

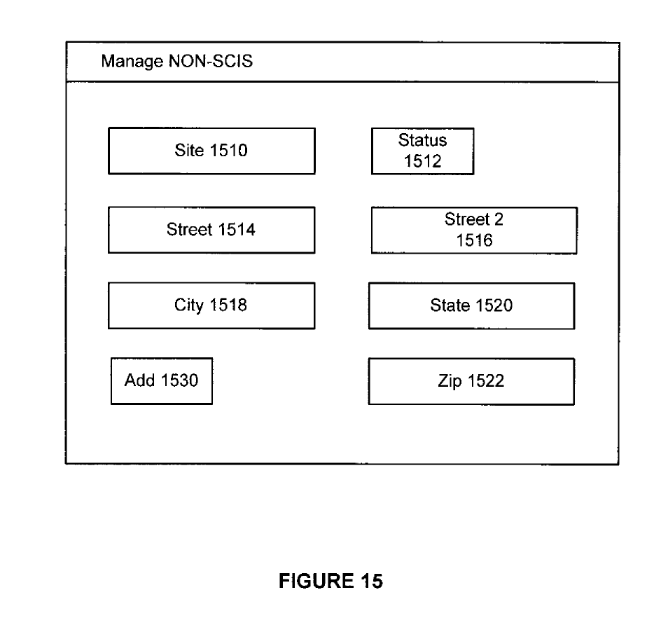

FIG. 15 is an exemplary illustration of an interface displaying a screen shot enabling a user to manage the site codes, according to a particular embodiment. When editing an entry, the values for that site may pre-populate the form. For a particular site, as displayed in Site 1510, a user may edit street address information 1514, 1516, city 1518, state 1520 and/or zip code 1522. Status 1512 provides the ability to enable or disable a non-SCIS site code. This allows the user to remove the site code from view of the application front-end but not remove the record from the system. If the user updates either the state or city, the user may reselect the appropriate city and zip since the parent item was modified. By selecting Add 1530, the changes may be accepted by the system.

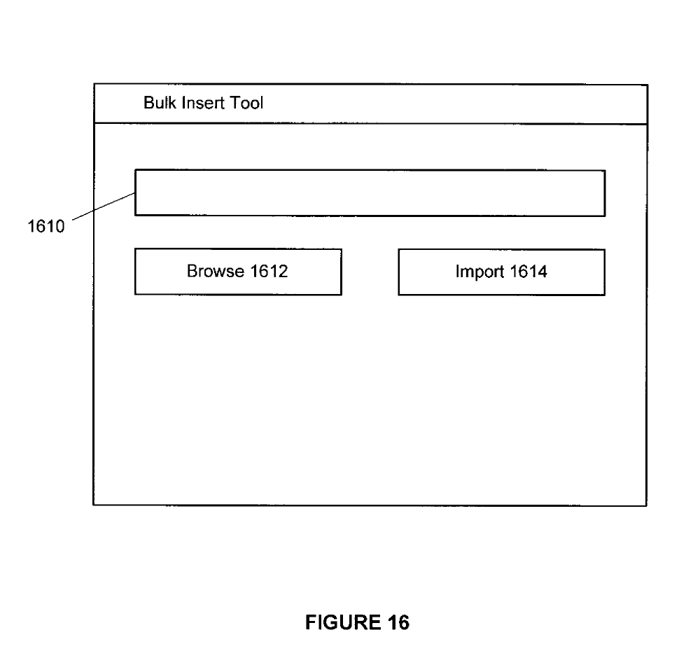

FIG. 16 is an exemplary illustration of an interface displaying a screen shot of a bulk insert, according to a particular embodiment. When selecting the bulk insert option, a window may appear that contains a red hyper-link labeled ‘Click Here to download Bulk Insert template. The template may contains rows of drop down menu options as-of the time the template was created. When the user selects a file to bulk load, the user may insert new records and/or update existing records. The user may enter a file identifier at 1610, or browse existing files by selecting 1612. By selecting Import 1614, the identified file may be imported. For example, the file may be processed where a progress file may be generated and returned to the user. In the event any rows failed to be inserted, those rows may be displayed in the progress report and the field that caused the failure may be highlighted for the failed row.

In the event a manager would like to provide access to the administrative features for their location, the manager may access the Non Manager Admin feature. This feature may allow the manager to add and input the user's email address into the form. This will provide the user access to all admin features except Non Manager Admin.

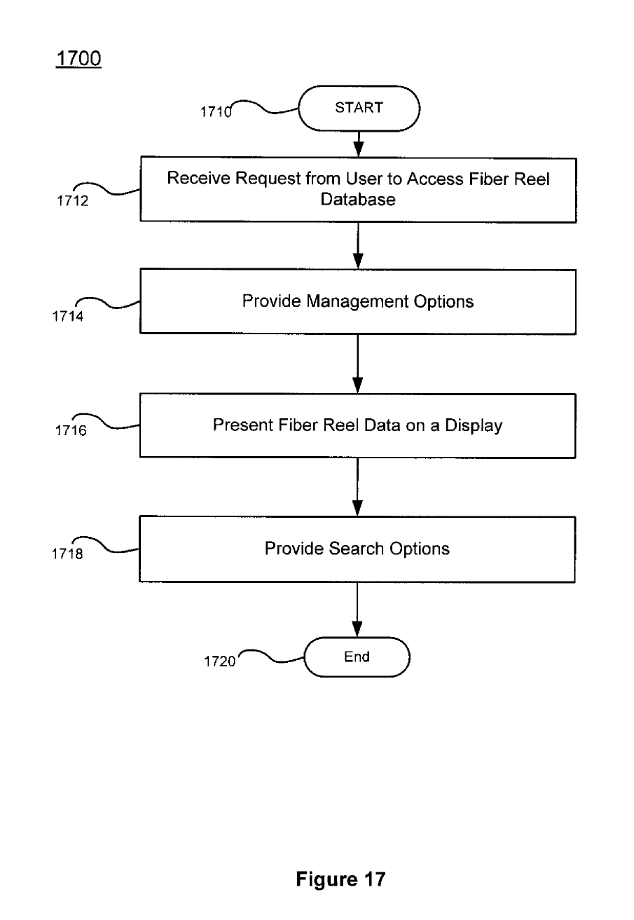

FIG. 17 is a flowchart illustrating the functionality of a particular embodiment. This method is provided by way of example, as there are a variety of ways to carry out the methods described herein. Method 1700 shown in FIG. 17 may be executed or otherwise performed by one or a combination of various systems. The method 1700 may be carried out through systems 100, 200 of FIGS. 1 and 2 by way of example, and various elements of FIGS. 1 and 2 are referenced in explaining method 1700 of FIG. 17. Each block shown in FIG. 17 represents one or more processes, methods, or subroutines carried out in method 1700. Method 1700 may begin at block 1710.

At block 1712, a system of an embodiment of the present invention may receive, via an input/output module, a request from a user to access a centralized database comprising fiber reel data for one or more locations.

At block 1714, one or more management options for managing fiber reel data may be provided to the user. The management options may be provided by a processor module. The more management options may include managing fiber reel data inventory on a location specific basis. Management options may include adding, editing and deleting fiber reel data. The management options may be visible or otherwise available to users with access to perform such actions.

The Add option 332 may allow the user to add fiber feel data to the inventory. The Edit option 336 may allow the user to modify an existing reel. For example, values may be pre-populated in the edit form. After clicking Delete 334 on a selected reel, the user may be prompted with a message requesting that the delete be verified before continuing.

When adding a new fiber reel, a window, such as FIG. 13, may appear. The site code input field may check against the FRDb site code list to validate site code name 1310. For Continuity 1213, the user may input the current date or this field may be automatically populated. Feet input 1314 and meters input 1316 may auto calculate the conversion and update the input box if either of the values are modified. Other input boxes may include Fiber Count 1318, Configuration 1320, Test by 1322, Molding Type 1324, Mode Type 1326, Cable Type 1328, Rodent Protection Type 1330, Manufacturer 1332 and Strength Member 1334 are managed through the administration panel. Other fields may include Copper Talk 1336, Reel Trailer 1338, Primary Contact 1340, First Alternate Contact 1342 and Second Alternative Contact 1344. By selecting the Add button 1346, a fiber reel may be added to inventory.

A user may also manage site codes. A Non-SCIS Site Code entry may be created in the event a reel is at a site that is not found in Site Code Information System (SCIS). Also, a user may edit information for each existing site code, such as street address information, city, state and/or zip code.

Other management options may also include importing and exporting options. When the user selects a file to bulk load, the user may insert new records and/or update existing records. The file may be processed where a progress file may be generated and returned to the user. In the event any rows failed to be inserted, those rows may be displayed in the progress report and the field that caused the failure may be highlighted for the failed row.

In addition, contact information specific for a site location may be managed. Upon selecting Update Location Contacts 322, a window—such as FIG. 4—may appear allowing the user to add or modify data related to a primary contact, as shown by 410, a first alternative contact, as shown by 412 and a second alternative contact, as shown by 414. The Primary Contact may be a required field and may not be left blank. These contacts may have predefined edit rights and may be notified via email or other form of communication during any change to a reel or site. A user may select an Update button 416 to effectuate the changes or confirm the current information.

At block 1716, a presentation module may displaying fiber reel data on a display. The display may include a tree panel, a location panel and an inventory panel with an option to view a map display.

Tree Panel 310 may display a hierarchical view of locations where each location may include fiber reel data specific to that location. The Tree Panel may include collapsible and expandable nodes. For example, within the USA, additional regions, such as states, may be displayed. Within each expandable state, sub-regions such as cities, counties or other defined areas may be displayed. By selecting an area in tree panel 310, the relevant details for the selected area may be displayed in main panel 312.

Location Panel 320 may provide fiber reel data detail for a location corresponding to a selected location on the tree panel 310. For example, site, address, city and site information may be provided. Other information may be available as well. The Location grid header may include Update Location Contacts 322 and Reel Export 324. Update Location Contacts 322 may be visible for users with access to modify contact information for that location. Location Panel 320 may include a site code and physical address information in addition to latitude and longitude values. Additional details may include extensive information about the location, change logs and other editing functions.

An Inventory Panel 330 may provide information concerning fiber reel data and also provide management options. The Inventory Panel 330 may display fiber reel data for each fiber reel. Data may include reel identifier, manufacturer, fiber count, meters, feet, molding type, strength member, cable type, etc.

At block 1718, a user may access a search function and provide search terms to search the centralized database based on one or more search terms. The search terms may include location based data. For example, as discussed above, FIG. 8 is an exemplary illustration of an interface displaying a screen shot of a map view, according to a particular embodiment. A map view may display physical locations of site or sites with graphics, such as red push pins. Each location may be displayed by location data which may include corresponding latitude-longitude coordinates. Locations may be displayed at the State, City and single site level. When the user hovers over a push pin location, details about the site may be displayed through a comment box 830. The comment box 830 may include the site code, physical address, latitude and longitude coordinates as well as other customized information.

As shown in FIG. 9, a Radius Search may allow a user to search within a defined area. When clicking the Radius Search, as shown as 344 in FIG. 3, a window may appear where the user may input search criteria, such as a start location 910, distance from the start location to search for fiber reels 912 and other available filtering mechanisms to further narrow and focus the search. Other criteria may be provided to further narrow the search results. For example, data relating to fiber length, including feet 916, meter 918, molding type 920, mode type 922, cable type 924, rodent production type 926, manufacturer 928, strength member 930, copper talk 932, reel trailer 934 may be entered. By selecting 936, search results may be provided via a map graphic, listing or other display. Corresponding results from radius search may appear in a map with graphics, as shown in FIG. 10. Results may be identified by red thumb-tacks or other graphic. Each thumb-tack when hovered over may display information in a comment box 1020 about where the reel is located.

In addition, an interface displaying a map view may also include driving directions to a selected site location. Upon selecting this option, the map may redraw, as shown by 1110, and provide turn by turn directions from the start location to a selected end route, as shown by 1120.

At block 1720, the process may end.

The description above describes communication devices, an application system, a communication network having network elements, storage devices, various networks, and other elements for coupling user via the communication network, some of which are explicitly depicted, others of which are not. As used herein, the term “module” may be understood to refer to computer executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
receiving, via an input/output module, a request from a user to access a centralized database comprising fiber reel data for one or more locations;
providing, via a processing module, one or more management options for managing fiber reel data to the user, wherein the one or more management options comprise managing fiber reel data inventory on a location specific basis; and
displaying fiber reel data, via a presentation module, on a display comprising a tree panel displaying a plurality of nodes where each node represents a site location, a location panel displaying location data for a site location and an inventory panel displaying fiber reel inventory data, the display further providing an option to view a map display illustrating fiber reel inventory for one or more site locations.

2. The method of claim 1, further comprising: providing search terms to search the centralized database based on one or more search terms.

3. The method of claim 2, wherein the one or more search terms comprise location data.

4. The method of claim 1, the one or more management options for a user is based at least in part on access authority assigned to the user.

5. The method of claim 1, further comprising: exporting fiber reel data for a selected site location.

6. The method of claim 1, wherein the location panel comprises an option to update location contacts and an option to export reel data.

7. The method of claim 1, wherein the inventory data comprises one or more of: reel identifier, manufacturer, fiber count and length.

8. The method of claim 1, wherein the inventory panel comprises an option to add a fiber reel, delete a fiber reel and edit a fiber reel.

9. The method of claim 1, wherein the map display provides a graphic indicating location of fiber reel data.

10. A computer readable medium comprising code to perform the steps of the methods of claim 1.

11. A computer based system, comprising:
an input/output module configured to receive a request from a user to access a centralized database comprising fiber reel data for one or more locations;
a processing module configured to provide one or more management options for managing fiber reel data to the user, wherein the one or more management options comprise managing fiber reel data inventory on a location specific basis; and
a presentation module configured to display on a display comprising a tree panel displaying a plurality of nodes where each node represents a site location, a location panel displaying location data for a site location and an inventory panel displaying fiber reel inventory data, the display further providing an option to view a map display illustrating fiber reel inventory for one or more site locations.

12. The system of claim 11, wherein the presentation module is further configured to provide search terms to search the centralized database based on one or more search terms.

13. The system of claim 12, wherein the one or more search terms comprise location data.

14. The system of claim 11, the one or more management options for a user is based at least in part on access authority assigned to the user.

15. The system of claim 11, wherein the processing module is further configured to export fiber reel data for a selected site location.

16. The system of claim 11, wherein the location panel comprises an option to update location contacts and an option to export reel data.

17. The system of claim 11, wherein the inventory data comprises one or more of: reel identifier, manufacturer, fiber count and length.

18. The system of claim 11, wherein the inventory panel comprises an option to add a fiber reel, delete a fiber reel and edit a fiber reel.

19. The system of claim 11, wherein the map display provides a graphic indicating location of fiber reel data.

20. The system of claim 11, wherein a bar code is displayed for a specific fiber reel.
